(19) United States
(12) Patent Application Publication
(10) Pub. No.: US 2015/0175787 A1
(43) Pub. Date: Jun. 25, 2015

(54) Tribologically Modified Ultrahigh Molecular Weight Polyethylene

(71) Applicant: Ticona GmbH, Sulzbach (DE)

(72) Inventors: Qamer Zia, Frankfurt (DE); Peter Raab, Eppstein (DE); Janine Bauer, Duisburg (DE)

(21) Appl. No.: 14/581,031

(22) Filed: Dec. 23, 2014

Related U.S. Application Data
(60) Provisional application No. 61/920,057, filed on Dec. 23, 2013.

(51) Int. Cl. C08L 23/06

(52) U.S. Cl. CPC C08L 23/06; C08L 2205/02; C08L 2207/068

(57) ABSTRACT

A tribologically modified ultrahigh molecular weight polyethylene (UHMW-PE) polymer composition is disclosed. The UHMW-PE polymer composition is comprised of an UHMW-PE polymer and at least one tribological modifier. The tribological modifier may be comprised of a silicone powder, a silicone oil, an olefin oligomer, an ultrahigh molecular weight silicone, or any combination thereof. The composition and polymer article produced therefrom may exhibit improved tribological properties, such as a reduced coefficient of friction and low wear, when contacted against a counter-material in comparison to an unmodified UHMW-PE polymer composition.

### RELATED APPLICATIONS

The present application claims priority to and is based on U.S. Provisional Patent Application Ser. No. 61/920,057, filed on Dec. 23, 2013, and which is hereby incorporated by reference.

### BACKGROUND

Ultrahigh molecular weight polyethylene (UHMW-PE) has become established as an exceptionally useful engineering material in a variety of applications, in part because of its unique combination of desirable properties. For instance, UHMW-PE polymers may exhibit an improved abrasion resistance, chemical resistance, lubricity, impact strength, stress crack resistance, heat deflection temperature, wear resistance, and energy absorption capacity at high stress rates in comparison to other thermoplastic polymers.

Consequently, UHMW-PE polymers have been utilized in a variety of applications. For instance, these polymers have been utilized in the textiles industry, food industry, packaging industry, paper industry, mechanical industry, etc. In particular, UHMW-PE polymers have been found to be excellent materials for sliding applications especially when compared with other thermoplastic materials partly due to the self-lubricating properties of the UHMW-PE polymers. These sliding applications may include applications where a polymer article comprising the UHMW-PE polymer is in moving contact with other counter-materials, such as those comprising metals, plastics, brass, copper, and the like.

However, with some current UHMW-PE compositions, the UHMW-PE article and/or the counter-material exhibit substantial wear when in moving contact. In some instances, the article and/or counter material may even exhibit melting. Consequently, current UHMW-PE compositions may exhibit undesirable tribological properties, in particular an undesirable coefficient of friction and wear resistance.

Although UHMW-PE polymer compositions have been modified in the past, further improvements are still necessary. For instance, improvements can be conducted for providing a composition comprising an UHMW-PE with improved tribological properties. In particular, a need exists for providing a composition and a polymer article produced therefrom with improved wear properties and a reduced coefficient of friction when in contact with other moving articles.

### SUMMARY

In general, the present disclosure is directed to an ultrahigh molecular weight polyethylene composition comprising an ultrahigh molecular weight polyethylene and at least one tribological modifier. The tribological modifier may be comprised of a silicone oil, an ultrahigh molecular weight silicone, a silicone powder, an olefin oligomer, or any combination thereof. The ultrahigh molecular weight polyethylene may be present in the composition in an amount of greater than about 75 wt. %. The tribological modifier may be present in the composition in an amount of from about 0.1 wt. % to about 20 wt. %.

In one embodiment, the tribological modifier may be comprised of a silicone oil. The silicone oil, in one embodiment, can have a relatively high viscosity, such as a viscosity greater than 10,000 mm²/s, such as greater than about 12,000 mm²/s, such as greater than about 15,000 mm²/s. In the one embodiment, the tribological modifier may be comprised of an olefin oligomer. In one embodiment, the tribological modifier may be comprised of a silicone oil in combination with an olefin oligomer. The olefin oligomer may be an α-olefin copolymer, such as an ethylene copolymer, such as an ethylene-butene copolymer.

In an alternative embodiment, the tribological modifier may comprise an ultrahigh molecular weight silicone or a silicone powder. The ultrahigh molecular weight silicone may comprise a silicone polymer with a linear chain that is not crosslinked. The silicone powder may be a core-shell silicone powder. In one embodiment, the silicone powder may be comprised of a silica and a silicone polymer such as an ultrahigh molecular weight silicone polymer. In addition, a coupling agent such as an alkoxysilane coupling agent may be present to bond the silica and the silicone polymer. In another embodiment, the silicone powder may be comprised of a silicone resin such as a polysilsesquioxane. In another embodiment, the silicone powder may be comprised of a silicone resin such as a polysilsesquioxane in combination with a silicone rubber.

In one embodiment, the silicone powder may be a core-shell silicone powder wherein the core is comprised of a silica and the shell is comprised of a silicone polymer such as an ultrahigh molecular weight silicone polymer. In another embodiment, the silicone powder may be a core-shell silicone powder wherein the core is a silicone rubber and the shell is a silicone resin such as a polysilsesquioxane. In another embodiment, the core may be a silicone resin such as a polysilsesquioxane that is not coated or does not comprise a shell.

In one embodiment, the silicone polymer may be non-functionalized. In another embodiment, the silicone polymer may be functionalized. For instance, the silicone polymer may be functionalized to comprise an acrylic group, an epoxy group, an amine group, or any combination thereof.

The tribological modifiers provide a composition with improved tribological properties. For instance, the composition exhibits a dynamic coefficient of friction against an unmodified polyoxymethylene of from about 0.05 to about 0.30, as measured at a sliding speed of 500 mm/s. In addition, the composition exhibits a dynamic coefficient of friction against an unmodified polyoxymethylene of from about 0.05 to about 1.0, as measured at a sliding speed of 1000 mm/s.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying FIGURES, in which:

FIG. 1 is a conveyor belt assembly comprising a wear strip and a conveyor chain.

Repeat use of the reference characters in the present specification and drawings is intended to represent the same or analogous features or elements of the present invention.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations.

In general, the present disclosure is directed to an ultrahigh molecular weight polyethylene (UHMW-PE) polymer composition and a polymer article comprising the composition. In general, the composition comprises an UHMW-PE polymer and at least one tribological modifier. For instance, the tribological modifier may include a silicone powder, a silicone oil, an ultrahigh molecular weight silicone, an olefin oligomer, or any combination thereof.

The tribological modifier can provide an UHMW-PE polymer composition and a polymer article produced therefrom with improved tribological properties. These properties may include higher abrasion resistance, improved sliding properties, improved wear properties, reduced frictional noise, and a reduced coefficient of friction when contacting the composition and/or polymer article against other surfaces. In particular, the composition and polymer article made from the composition may exhibit improved tribological properties when contacted against other surfaces or counter-materials while still exhibiting desirable mechanical properties.

According to the present disclosure, the polymer composition is comprised of an ultrahigh molecular weight polyethylene (UHMW-PE).

As used herein, an UHMW-PE may have an average molecular weight, as determined according to ASTM D4020, of at least or greater than 3,000,000 g/mol, such as at least about 5,000,000 g/mol, such as at least about 10,000,000 g/mol and generally less than about 20,000,000 g/mol, such as less than about 15,000,000 g/mol, such as less than about 12,000,000 g/mol, such as less than about 10,000,000 g/mol, such as less than about 7,500,000 g/mol, such as less than about 6,000,000 g/mol.

Generally, a high molecular weight polyethylene may have a molecular weight of from 300,000 g/mol to 1,000,000 g/mol and a very high molecular weight polyethylene may have a molecular weight of at least or greater than 1,000,000 g/mol to less than 3,000,000 g/mol.

The UHMW-PE may be a homopolymer, a copolymer, or a blend thereof. In one embodiment, the UHMW-PE may be a homopolymer. For instance, in one embodiment, the UHMW-PE is a homopolymer of ethylene.

In another embodiment, the UHMW-PE may be a copolymer. For instance, the UHMW-PE may be a copolymer of ethylene and another olefin containing from 3 to 16 carbon atoms, such as from 3 to 10 carbon atoms, such as from 3 to 8 carbon atoms. These other olefins include, but are not limited to, propylene, 1-butene, 1-pentene, 1-hexene, 1-heptene, 1-octene, 4-methylpent-1-ene, 1-decene, 1-dodecene, 1-hexadecene and the like. Also utilizable herein are polyene comonomers such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene. However, when present, the amount of the non-ethylene monomer(s) in the copolymer may be less than about 10 mol. %, such as less than about 5 mol. %, such as less than about 2.5 mol. %, such as less than about 1 mol. %, wherein the mol. % is based on the total moles of monomer in the polymer.

In one embodiment, the UHMW-PE may exhibit a bimodal molecular weight distribution. For instance, a bimodal distribution generally refers to a polymer having a distinct higher molecular weight and a distinct lower molecular weight (e.g. two distinct peaks) on a size exclusion chromatography or gel permeation chromatography curve. In another embodiment, the UHMW-PE may exhibit more than two molecular weight distribution peaks such that the UHMW-PE exhibits a multimodal (e.g., trimodal, tetramodal, etc.) distribution. Alternatively, the UHMW-PE may exhibit a broad molecular weight distribution wherein the UHMW-PE is comprised of a blend of higher and lower molecular weight components such that the size exclusion chromatography or gel permeation chromatography curve does not exhibit at least two distinct peaks but instead exhibits one distinct peak broader than the individual component peaks.

In one embodiment, the composition may be comprised of more than one UHMW-PE polymer, each having a different molecular weight and/or molecular weight distribution. For instance, the molecular weight distribution may be within the average molecular weight specifications provided above.

In addition, the composition may be comprised of a blend of one or more UHMW-PE polymers or copolymers and another thermoplastic polymer such as a polypropylene or a polybutylene. However, the amount of non-polyethylene polymer(s) in the composition may be less than about 10 wt. %, such as less than about 5 wt. %, such as less than about 2.5 wt. %, such as less than about 1 wt. %, wherein the wt % is based on the total weight of the composition.

Any method known in the art can be utilized to synthesize the UHMW-PE. The high molecular weight polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene is usually polymerized in gaseous phase or slurry phase at relatively low temperatures and pressures. The polymerization reaction may be carried out at a temperature of between 50° C. and 100° C. and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid wall fouling and product contamination.

Suitable catalyst systems include but are not limited to Ziegler-Natta type catalysts. Typically Ziegler-Natta type catalysts are derived by a combination of transition metal compounds of Groups 4 to 8 of the Periodic Table and alkyl or hydrid derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system could be obtained by the reaction of a titanium(IV) compound with a trialkyl aluminum compound in an inert organic solvent at temperatures in the range of −40° C. to 100° C., preferably −20° C. to 50° C. The concentrations of the starting materials are in the range of 0.1 to 9 mol/L, preferably 0.2 to 5 mol/L, for the titanium(IV) compound and in the range of 0.01 to 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40° C. to 200° C., preferably −20° C. to 150° C. In the first step the titanium(IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium(IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100° C. In a second reaction stage the reaction mixture formed is subjected to heat treatment for a period of about 10 to 100 hours at a temperature of 110° to 200° C. accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium-magnesium and zinc stearate.

Optionally, other catalysts such as Phillips catalysts, metallocenes and post metallocenes may be employed. Generally a cocatalyst such as alumoxane or alkyl aluminum or alkyl magnesium compound is also employed. For example, U.S. Patent Application Publication No. 2002/0040113 to Fritzsche et al., the entire contents of which are incorporated herein by reference, discusses several catalyst systems for producing ultra-high molecular weight polyethylene. Other suitable catalyst systems include Group 4 metal complexes of phenolate ether ligands such as are described in International Patent Publication No. WO2012/004675, the entire contents of which are incorporated herein by reference.

The UHMW-PE may be manufactured in the form of a powder such as a micropowder. For instance, the UHMW-PE power may be a free-flowing powder. The powder may have an average particle size, d50, of no more than 2,000 μm, such as between about 10 and about 1,500 μm, such as from about 50 μm to about 650 μm, such as from about 50 to about 400 μm, such as from about 50 to about 200 μm. Preferably, the as-synthesized polymer has the desired particle size. However, if the as-synthesized polymer has a particle size in excess of the desired value, the particles can be ground to the desired particle size. The powder particle size can be measured utilizing a laser diffraction method according to ISO 13320.

The bulk density of the UHMW-PE powder is typically between 0.1 and 0.5 g/ml, such as between 0.2 and 0.45 g/ml. The UHMW-PE powder bulk density measurements can be obtained according to DIN 53466.

The UHMW-PE may have a viscosity number of from at least 100 mL/g, such as at least 500 mL/g, such as at least 1,500 mL/g, such as at least 2,000 mL/g, such as at least 4,000 mL/g to less than about 6,000 mL/g, such as less than about 5,000 mL/g, such as less than about 4000 mL/g, such as less than about 3,000 mL/g, such as less than about 1,000 mL/g, as determined according to ISO 1628 part 3 utilizing a concentration in decahydronapthalene of 0.0002 g/mL.

The UHMW-PE may have a crystallinity of from at least about 40% to 85%, such as from 45% to 80%.

The UHMW-PE may be present in the composition in an amount of greater than about 50 wt. %, such as greater than about 75 wt. %, such as greater than about 80 wt. %, such as greater than about 85 wt. %, such as greater than about 87.5 wt. %, such as greater than about 92.5 wt. %, such a greater than about 95 wt. % and less than about 100 wt. %, such as less than about 97 wt. %, such as less than about 95 wt. %, such as less than about 92 wt. %, such as less than about 90 wt. %.

According to the present disclosure, the polymer composition and polymer article produced therefrom may be comprised of at least one tribological modifier. For instance, the tribological modifier may be comprised of a silicone oil, an olefin oligomer, an ultrahigh molecular weight silicone, a silicone powder, or any combination thereof.

The tribological modifiers may improve the tribological properties of the composition by imparting lubricity and reducing friction between the composition and other components and/or counter-materials. In addition, they may provide a composition with improved mold releasability, minimized mold fouling, improvement in fluidity, and an increase in mold cycles due to a reduction in mold temperature and/or decrease in cooling time.

In one embodiment, the tribological modifier may be comprised of a silicone oil. The silicone oil may comprise a siloxane or a liquid siloxane, such as a liquid polysiloxane having the below molecular weight and/or kinematic viscosity specifications at a room temperature of 25° C. In one embodiment, the silicone oil may be a liquid polydimethylsiloxane.

The silicone oil may have an average molecular weight of at least about 100 g/mol, such as at least about 500 g/mol, such as at least about 1,000 g/mol, such as at least about 5,000 g/mol, such as at least about 10,000 g/mol and generally less than 100,00 g/mol, such as less than about 75,000 g/mol, such as less than about 50,000 g/mol, such as less than about 25,000 g/mol, such as less than about 10,000 g/mol, such as less than about 1,000 g/mol. The silicone oil may have a kinematic viscosity at 40° C. measured according to DIN 51562 of greater than about 10,000 mm²s⁻¹, such as greater than about 12,000 mm²s⁻¹, such as greater than about 15,000 mm²s⁻¹, such as greater than about 20,000 mm²s⁻¹ and generally less than 100,000 mm²s⁻¹, such as less than about 50,000 mm²s⁻¹, such as less than about 40,000 mm²s⁻¹, such as less than about 35,000 mm²s⁻¹.

When present, the silicone oil may be present in an amount of greater than about 0.1 wt. %, such as greater than about 0.5 wt. %, such as greater than about 1 wt. %, such as greater than about 1.5 wt. %, such as greater than about 2.5 wt. % and generally less than about 15 wt. %, such as less than about 10 wt. %, such as less than about 8 wt. %, such as less than about 3 wt. %

In one embodiment, the tribological modifier may be comprised of an olefin oligomer. For instance, the olefin oligomer may be a polyolefin oligomer. In one embodiment, the olefin oligomer, such as the polyolefin oligomer, may have a low molecular weight.

For instance, in one embodiment, the average molecular weight, as measured by gel permeation chromatography, may be at least about 100 g/mol, such as at least about 400 g/mol, such as at least about 1,000 g/mol, such as at least about 1,500 g/mol and generally less than about 50,000 g/mol, such as less than about 25,000 g/mol, such as less than about 10,000 g/mol, such as less than about 5,000 g/mol, such as less than about 4,000 g/mol, such as less than about 3,000 g/mol. In addition, the ratio (Mw/Mn) of the weight-average molecular weight (Mw) to the number-average molecular weight (Mn) may be in the range of from 1.2 to 4.0, such as from 1.5 to 3.5, such as from 1.5 to 3.0.

The olefin oligomer may be a homopolymer or a copolymer of α-olefin(s). For instance, a homopolymer may be a homopolymer of an α-olefin including ethylene, propylene, 1-butene, 1-pentene, 1-hexene, 1-heptene, 4-methyl-1-pentene, 1-octene, and the like. In one embodiment, the olefin oligomer is a polyethylene oligomer that is a homopolymer of ethylene.

In another embodiment, the olefin oligomer may be a copolymer comprised of ethylene and an α-olefin having 3 to 20 carbon atoms, such as 3 to 10 carbon atoms, such as 3 to 8 carbon atoms. In another embodiment, the olefin oligomer may be a copolymer comprised of propylene and an α-olefin having 4 to 20 carbon atoms, such as 4 to 10 carbon atoms, such as 4 to 8 carbon atoms. For instance, the α-olefin may be propylene, 1-butene, 1-pentene, 1-hexene, 1-heptene, 4-methyl-1-pentene, 1-octene, 1-decene, 1-dodecene, 1-tetradecene, 1-hexadecene, 1-eicosene, and the like. For instance, the copolymer may be an ethylene-propylene copolymer, ethylene-butene copolymer, ethylene-pentene copolymer, propylene-butene copolymer, propylene-pentene copolymer, and the like.

In one embodiment, the composition is comprised of an ethylene-α-olefin copolymer comprising an ethylene-butene copolymer. For instance, the ethylene-α-olefin copolymer may be a copolymer comprising from 99 to 25 mol. %, such as from 99 to 50 mol. % of ethylene and from 1 to 50 mol. %, such as from 1 to 25 mol. % of another α-olefin as identified above. A propylene-α-olefin copolymer may be a copolymer comprising from 99 to 25 mol. %, such as from 99 to 50 mol. % of propylene and from 1 to 50 mol. %, such as from 1 to 25 mol. % of another α-olefin as identified above. The ethylene-butene copolymer, for instance, may have a viscosity average molecular weight of from about 1,000 g/mol to about 10,000 g/mol, such as from about 3,500 g/mol to about 6,000 g/mol.

In one embodiment, the composition may be comprised of an ethylene-α-olefin copolymer such as an ethylene-butene copolymer in combination with a second tribological modifier, such as silicone oil. When both are present, the ratio of olefin oligomer, such as ethylene-butene copolymer, to the second tribological modifier, such as silicone oil, may be from 10:1 to 1:10, such as from 5:1 to 1:5, such as from 3:1 to 1:3, such as from 1:1 to 1:2. The present inventors have discovered that when utilizing both modifiers in combination, a composition and article exhibiting even more improved tribological properties can be obtained. For instance, not to be limited by theory, the olefin oligomer may act as a lubricant and further reduce the friction between the components and impart lubricity to the composition. By doing so, the composition and article produced utilizing both components may present even further improved tribological properties.

The olefin oligomer may be prepared utilizing a Ziegler catalyst or a metallocene catalyst. In one embodiment, the olefin oligomer is a polyethylene oligomer, such as a homopolymer of ethylene or a copolymer of ethylene and an α-olefin having 3 to 20 carbon atoms such as 1-butene, prepared using a metallocene catalyst. Accordingly, in one embodiment, the olefin oligomer may be a metallocene catalyzed olefin oligomer as described in U.S. Patent Application Publication No. 2007/0100056 to Uosaki et al., which is incorporated herein by reference in its entirety.

The olefin oligomer may have a density of at least about 0.80 g/mL, such as at least about 0.85 g/mL, such as at least about 0.88 g/mL, such as at least about 0.95 g/mL and less than about 1.2 g/mL, such as less than about 1.0 g/mL, such a less than about 0.95 g/mL, such as less than about 0.92 g/mL. The density may be measured utilizing a density gradient tube process in accordance with JIS K7112.

The olefin oligomer may have a melting point as determined utilizing differential scanning calorimetry of from at least about 65° C., such as at least about 70° C., such as at least about 80° C. to less than about 135° C., such as less than about 110° C., such as less than about 100° C.

When present, the olefin oligomer, such as the polyethylene oligomer such as the ethylene-butene copolymer, may be present in the composition in an amount of greater than about 0.1 wt. %, such as greater than about 1 wt. %, such as greater than about 1.5 wt. %, such as greater than about 2 wt. % and less than about 10 wt. %, such as less than about 5 wt. %, such as less than about 4 wt. %, such as less than about 3.5 wt. %.

In one embodiment, the tribological modifier may be comprised of an ultrahigh molecular weight silicone. The ultrahigh molecular weight silicone may be a linear silicone that is not crosslinked.

In general, the UHMW-Si may have an average molecular weight of greater than about 100,000 g/mol, such as greater than about 200,000 g/mol, such as greater than about 300,000 g/mol, such as greater than 500,000 g/mol and less than about 5,000,000 g/mol, such as less than about 3,000,000 g/mol, such as less than about 2,000,000 g/mol, such as less than about 1,000,000 g/mol, such as less than about 500,000 g/mol, such as less than about 300,000 g/mol. Generally, the UHMW-Si may have a kinematic viscosity at 40° C. measured according to DIN 51562 of greater than about 100,000 mm²s⁻¹, such as greater than about 200,000 mm²s⁻¹, such as greater than about 1,000,000 mm²s⁻¹, such as greater than about 5,000,000 mm²s⁻¹, such as greater than about 10,000,000 mm²s⁻¹, such as greater than about 15,000,000 mm²s⁻¹ and less than about 50,000,000 mm²s⁻¹, such as less than about 25,000,000 mm²s⁻¹, such as less than about 10,000,000 mm²s⁻¹, such as less than about 1,000,000 mm²s⁻¹, such as less than about 500,000 mm²s⁻¹, such as less than about 200,000 mm²s⁻¹.

The UHMW-Si may comprise a siloxane such as a polysiloxane or polyorganosiloxane. In one embodiment, the UHMW-Si may comprise a dialkylpolysiloxane such as a dimethylsiloxane, an alkylarylsiloxane such as a phenylmethylsilaoxane, or a diarylsiloxane such as a diphenylsiloxane, or a homopolymer thereof such as a polydimethylsiloxane or a polymethylphenylsiloxane, or a copolymer thereof with the above molecular weight and/or kinematic viscosity requirements. The polysiloxane or polyorganosiloxane may also be modified with a substituent such as an epoxy group, a hydroxyl group, a carboxyl group, an amino group or a substituted amino group, an ether group, or a meth(acryloyl) group in the end or main chain of the molecule. The UHMW-Si compounds may be used singly or in combination. Any of the above UHMW-Si compounds may be used with the above molecular weight and/or kinematic viscosity requirements.

In one embodiment, the ultrahigh molecular weight silicone may be added to the polymer composition as a masterbatch where the silicone is dispersed in a polypropylene polymer, such as a polyethylene polymer.

The UHMW-Si may be present in the composition in an amount of at greater than about 0 wt. %, such as at greater than about 0.1 wt. %, such as at greater than about 0.5 wt. %, such as at greater than about 0.75 wt. %, such as at greater than about 1 wt. %, such as at greater than about 2 wt. %, such as at greater than about 2.5 wt. % and generally less than about 10 wt. %, such as less than about 6 wt %, such as less than about 5 wt. %, such as less than about 4 wt. %, such as less than about 3.5 wt. %, such as less than about 3 wt. %, wherein the weight is based on the total weight of the polymer composition.

In one embodiment, the tribological modifier may be comprised of a silicone powder. For instance, the silicone powder may be a powder comprising a silicone polymer.

In one embodiment, the powder may contain a silicone polymer such as a polysiloxane. The polysiloxane may be an ultrahigh molecular weight silicone (UHMW-Si) polymer as described above. For instance, the silicone polymer may be an ultrahigh molecular weight polydialkylsiloxane such as an ultrahigh molecular weight polydimethylsiloxane. The polydialkylsiloxane may have a viscosity of greater than 100,000 mm²s⁻¹, such as greater than 300,000 mm²s⁻¹, such as greater than 1,000,000 mm²s⁻¹ and generally less than about 30,000,000 mm²s⁻¹, such as less than about 20,000,000 mm²s⁻¹, such as less than about 10,000,000 mm²s⁻¹. In general, the UHMW-Si may have an average molecular weight of greater than 100,000 g/mol, such as greater than about 200,000 g/mol, such as greater than about 300,000 g/mol, such as greater than 500,000 g/mol and less than about 5,000,000 g/mol, such as less than about 3,000,000 g/mol, such as less than about 2,000,000 g/mol, such as less than about 1,000,000 g/mol, such as less than about 500,000 g/mol, such as less than about 300,000 g/mol.

In another embodiment, the polysiloxane may be a low molecular weight silicone polymer. For instance, the polysiloxane may be a low molecular weight polydialkylsiloxane, such as a polydimethylsiloxane, having a viscosity of less than 100,000 mm²s⁻¹, such as less than about 50,000 mm²s⁻¹, such as less than about 25,000 mm²s⁻¹ and generally greater than about 100 mm²s⁻¹, such as greater than about 500 mm²s⁻¹. In general, the low molecular weight silicone polymer may have an average molecular weight of less than 100,000 g/mol, such as less than 50,000 g/mol, such as less than 25,000 g/mol, such as less than 10,000 g/mol, such as less than 5,000 g/mol, such as less than 1,000 g/mol and generally greater than 10 g/mol, such as greater than 100 g/mol, such as greater than 500 g/mol. In such embodiments, the low molecular weight silicone polymer may not be a silicone oil, such as a liquid silicone polymer, but instead a silicone powder comprising a low molecular weight silicone polymer.

The silicone polymer such as the polysiloxane may contain functional groups in the molecular chain or may not contain functional groups in the molecular chain. Accordingly, in one embodiment, the silicone powder may be non-functionalized. In an alternative embodiment, the silicone powder may be functionalized. When the silicone polymer contains functional groups, the functional groups may include epoxy groups, amine groups or substituted amine groups such as alkylamines, hydroxyl groups, acrylate groups such as methacrylate, ethyl acrylate, propyl acrylate, butyl acrylate, and the like.

In one embodiment, the silicone powder may also be comprised of a reinforcing filler, such as a silica. In another embodiment, the silicone powder may also be comprised of a reinforcing filler, such as a silica and a coupling agent. When blended in the presence of heat, the coupling agent may bond to the silica particles. Generally, not to be limited by theory, when in the presence of a silicone polymer, the silane coupling agent bonded silica particle may further bond with the silicone polymer. For instance, the silicone polymer may also bond with the coupling agent that is bonded to the silica. Accordingly, the silicone polymer may be utilized to coat the silica.

Accordingly, in one embodiment, the silicone powder may be a core-shell silicone powder comprising a silica core and a silicone polymer shell. Accordingly, the silicone powder may be comprised of a silica surface treated with a silane and a silicone polymer. The combination of the silica and silicone powder may improve the properties of the composition. For instance, not to be limited by theory, the silica may also provide acidic silanol sites which may bond or crosslink with the silicone such as the polysiloxane such as the polydimethylsiloxane. In one embodiment, the silicone polymer on the surface may be an ultrahigh molecular weight polysiloxane. In another embodiment, the silicone polymer on the surface may be a low molecular weight polysiloxane. In an even further embodiment, the silicone polymer may be a polysilsesquioxane, as further defined herein.

The silicone polymer such as the ultrahigh molecular weight polysiloxane may be attached to the silica according to any method known in the art. For instance, the silicone polymer such as the UHMW-Si may be attached or bonded to the silica by physical anchoring. In another embodiment, the bonding or attachment may be a chemical reaction or process such as a coupling between the silicone polymer and the silica.

In the core-shell silicone powder, the silica may be present in an amount of at least about 0.1 wt. %, such as at least about 1 wt. %, such as at least about 5 wt. %, such as at least about 10 wt. %, such as at least about 25 wt. % and generally less than about 65 wt. %, such as less than about 60 wt. %, such as less than about 55 wt. %, such as less than about 40 wt. %, such as less than about 20 wt. %, based on the total weight of the silicone polymer, silica, and alkoxysilane(s). For instance, the weight ratio of silica to silicone polymer may be from 9:1 to 1:9, such as from 8:2 to 2:8, such as from 6:4 to 4:6.

The silica may be a fumed silica, precipitated silica, or mine silica. Generally, the silica has a surface area of from 50 m²/g to 900 m²/g, such as from 50 m²/g to 400 m²/s. Any silica may be used with the present disclosure. In one embodiment, the silica is preferred to carry a polysiloxane polymer on the surface by absorption or adsorption.

The coupling agent may be any coupling agent known in the art. For instance, the coupling agent may be an alkoxysilane coupling agent or an aminosilane coupling agent. The alkoxysilane coupling agent may be a trialkoxysilane coupling agent, a dialkoxysilane coupling agent, or a monoalkoxysilane coupling agent. For instance, the alkoxysilane may have at least one C₁-C₄ alkoxyl group and/or at least one group selected from epoxy, acryloxy, methacryloxy, vinyl, phenyl and N-β-(N-vinylbenzylamino)ethyl-γ-aminoalkyl hydrochloride. In one embodiment, the alkoxysilane may be comprised of a trimethoxysilane, a triethoxysilane, or the like. The coupling agent may be present in an amount of from about 0.1 wt. % to 20 wt. %, such as from 0.1 wt. % to 15 wt. %, wherein the weight is based on the weight of the silica.

In another embodiment, the silicone powder may have a core comprised of a silicone polymer. For instance, the core may be comprised of a silicone polymer such as a silicone rubber. The silicone rubber may be a cured diorganopolysiloxane wherein the polysiloxane comprises an unsubstituted or substituted hydrocarbon group having 1 to 20 carbon atoms such as alkyl groups including methyl, ethyl, propyl, butyl, aryl groups such as phenyl and tolyl groups, alkenyl groups such as vinyl and allyl groups and aralkyl groups. For instance, the diorganopolysiloxane may be a dialkylpolysiloxane or an alkylarylpolysiloxane and the like.

As just one example, the silicone rubber can be obtained by an addition reaction between an organopolysiloxane, such as a vinyl group containing organopolysiloxane having at least two silicon-bonded vinyl groups, and a crosslinking agent, such as an organohydrogenpolysiloxane, in the presence of a catalytic amount of a platinum compound. This reaction would result in the formation of crosslinks including the condensation reaction between silicon-bonded alkoxy groups and silanol groups, a radical reaction between silicon-bonded mercapto groups and silicon-bonded vinyl groups, etc. Accordingly, the core may be comprised of a crosslinked silicone polymer. For instance, the silicone polymer may be a polydimethylsiloxane polymer. The crosslinked silicone polymer may be a crosslinked UHMW-Si polymer such as a crosslinked polydimethylsiloxane polymer. The polymer may be crosslinked using any method known in the art.

The shell may also be comprised of a silicone polymer. For instance, in one embodiment, the shell may be comprised of an UHMW-Si polymer, a low molecular weight silicone polymer, or a combination thereof. In one embodiment, the shell may be comprised of a polyorganosilsesquioxane resin or a polysilsesquioxane resin. For instance, these resins may be comprised of trifunctional organosiloxane units represented by the formula R¹SiO_{3/2} wherein R¹ is an unsubstituted or substituted monovalent hydrocarbon group having 1 to 20 carbon atoms exemplified by alkyl groups such as methyl, ethyl, propyl and butyl groups, aryl groups such as phenyl and tolyl groups, alkenyl groups such as vinyl and allyl groups and aralkyl groups such as 2-phenylethyl and 2-phenylpropyl groups as well as those substituted hydrocarbon groups obtained by replacing a part or all of the hydrogen atoms in the above named hydrocarbon groups with substituents

For instance, the silicone polymer such as the polyorganosilsequioxane resin may be polymerized on at least a part of the silicone polymer such as the silicone rubber or crosslinked organopolysiloxane comprising the core. Accordingly, the silicone polymer comprising the core may be coated with a silicone resin. These silicone powders may be produced as described in U.S. Pat. No. 5,538,793 to Inokuchi et al, which is incorporated herein by reference in its entirety.

In one embodiment, it is preferred that at least 50 mol. % of the groups on the polyorganosilsesquioxane are methyl groups. Asides from the trifunctional siloxane units, the silicone resin may be comprised of a small amount of monofunctional, difunctional and/or tetrafunctional siloxane units. Generally, the silicone resin is coated on the cured silicone polymer such as the cured silicone rubber core in an amount of from 1 to 500 parts by weight, such as from 5 to 100 parts by weight per 100 parts by weight of the cured silicone rubber forming the core particles.

As just one example, the powder may be produced by adding an alkaline substance or alkaline aqueous solution and an organotrialkoxysilane to an aqueous dispersion of spherical silicone rubber particles having an average diameter of, for example, from 0.1 to 20 μm, such as from 0.1 to 10 μm and, then, hydrolyzing and polymerizing the organotrialkoxysilane on the surface of the spherical silicone rubber followed by drying. The hydrolysis-condensation reaction will form the silicone resin such as the polyorganosilsesquioxane resin.

The trialkoxy silane compound to be subjected to the hydrolysis-condensation reaction is represented by the general formula R¹Si(OR²)₃ wherein R¹ has the same meaning as defined above and R² is an alkyl group having 1 to 6 carbon atoms such as methyl, ethyl, propyl and butyl groups. Examples of suitable trialkoxy silane compounds include methyl trimethoxy silane, methyl triethoxy silane, methyl tripropoxy silane, methyl tributoxy silane, ethyl trimethoxy silane, propyl trimethoxy silane, butyl trimethoxy silane, N-(2-aminoethyl)-3-aminopropyl trimethoxy silane, 3-glycidyloxypropyl trimethoxy silane, vinyl trimethoxy silane, phenyl trimethoxy silane, 3-methacryloxypropyl trimethoxy silane, 3-mercaptopropyl trimethoxy silane, 3,3,3-trifluoropropyl trimethoxy silane, 2-(perfluoro-n-butyl)ethyl trimethoxy silane and 2-(per-fluoro-n-octyl)ethyl silane. These trialkoxy silane compounds can be used either singly or as a combination of two kinds or more according to need. Although it is preferable that at least 50% by moles of the trialkoxy silane compounds used in the inventive method is methyl trimethoxy silane, certain additional improvements can be obtained by the combined use thereof with other functional trialkoxy silane compounds in respect of the compatibility of the silicone resin-coated silicone rubber particles with various kinds of matrix materials and the surface lubricity of the shaped articles prepared from a composition compounded with the particles. The reaction can yield a silicone powder comprising a silicone rubber core coated with a shell comprising a silicone resin.

In one embodiment, the silicone polymer in the shell may be comprised of a crosslinked silicone polymer. In another embodiment, the silicone polymer in the shell may be comprised of a non-crosslinked silicone polymer.

Generally, the core-shell configuration may improve the properties of the composition. Not to be limited by theory, for instance, the shell may provide the particle or powder with a surface of higher hardness and may also have a higher surface energy. In addition, the surface treatment may also allow for better adhesion with the other components of the composition.

In another embodiment, the silicone powder may be a fine silicone particle. For instance, the powder such as the fine particles may be comprised of a crosslinked silicone polymer. In one embodiment, the fine particles may be comprised of a silicone resin such as a polyorganosilsesquioxane as described above and as further described in JPS 54-72300, JPH 03-244636, JPH 04-88023, and U.S. Pat. No. 4,528,390 to Kimura, which is incorporated herein by reference in its entirety. For instance, these may include three-dimensional crosslinking of linear organopolysiloxanes. In one embodiment, the particles may be comprised of a polyalkylsilsesquioxane such as a polymethylsilsesquioxane, and the like. For instance, the polysilsesquioxane can be obtained utilizing a trifunctional siloxane such as a methyltrialkoxysilane, such as a methyltrimethoxysilane, methyltriethoxysilane, and the like. To produce the powder, as an example, in one embodiment, the trifunctional siloxane can be hydrolyzed and condensed in an aqueous solution of ammonia or an amine and thereafter cooled, precipitated and washed to obtain the final polyorganosilsesquioxane such as a polymethylsilsesquioxane powder.

The silicone powder may have a structure wherein the siloxane bonds are crosslinked in a three dimensional network represented by (RSiO_{3/2})ₙ. For instance, these silicone powders may include but are not limited to fine powder of crosslinked spherical dimethylpolysiloxane (which partly has the crosslinked structure of dimethylpolysiloxane), fine powder of crosslinked spherical polymethylsilsesquioxane, fine powder of crosslinked spherical dimethylpolysiloxane rubber (having its surface coated with polymethylsilsesquioxane), fine powder of crosslinked spherical diphenylpolysiloxane rubber (having its surface coated with polymethylsilsesquioxane), and hydrophobic silica.

The silicone powder may be a spherical powder. The silicone powder may be present as a free-flowing powder. The silicone powder may have a particle diameter of at least about 0.5 μm, such as at least about 1.5 μm and generally less than about 50 μm, such as less than about 10 μm, such as less than about 5 μm, such as less than about 3 μm. In general, the average diameter is measured by laser diffraction and scattering method.

In one embodiment, the silicone powder may be halogen free such that the powder is not comprised of any halogen atoms or groups.

The silicone powder may be prepared utilizing any method known in the art.

The silicone powder(s) described herein may be used alone or in combination. The silicon powder may be present in the composition in an amount of greater than about 0.1 wt. %, such as greater than about 0.5 wt. %, such as greater than about 1 wt. %, such as greater than about 2 wt. %, such as greater than about 4 wt. % and generally less than about 30 wt. %, such as less than about 20 wt. %, such as less than about 15 wt. %, such as less than about 12 wt. %, such as less than about 7 wt. %.

In one embodiment, the polymer composition may contain a mixture of tribological modifiers. For instance, the composition may contain a silicone powder or an ultrahigh molecular weight silicone in combination with a silicone oil and/or an olefin polymer. In one embodiment, one of the above described tribological modifiers may be combined with a polytetrafluoroethylene.

The PTFE may be in the form of a powder, such as a micropowder. In another embodiment, the PTFE may be in the form of a fiber. The PTFE may have a mean particle diameter, as measured according to ISO 13320, of at least about 1 μm, such as at least about 4 μm, such as at least about 7 μm and less than about 50 μm, such as less than about 20 μm, such as less than about 15 μm, such as less than about 12 μm. The bulk density of the PTFE is typically between 0.1 and 0.5 g/ml, such as between 0.2 and 0.45 g/ml, as measured according to DIN EN ISO 60. The powders may have a specific surface area measured according to DIN ISO 9277 of greater than 0.1 m²/g, such as greater than 1 m²/g, such as greater than 5 m²/g and less than 100 m²/g, such as less than 50 m²/g, such as less than 25 m²/g, such as less than 15 m²/g. When present, the PTFE may be present in an amount of greater than 0.1 wt. %, such as greater than 1 wt. %, such as greater than 1.5 wt. %, such greater than 2 wt. %, such as at greater than 4 wt. % and less than about 40 wt. %, such as less than about 20 wt. %, such as less than about 10 wt. %, such as less than about 8 wt. %.

The polymer composition and polymer article produced therefrom may also contain other known additives such as, for example, antioxidants, UV stabilizers, light stabilizers, heat stabilizers, reinforcing fibers or fillers, lubricants, optical brighteners, colorants, demolding agents, crosslinking agents, plasticizers, pigments, antistatic agents, and the like.

In one embodiment, a heat stabilizer may be present in the composition. The heat stabilizer may include, but is not limited to, phosphites, aminic antioxidants, phenolic antioxidants, or any combination thereof.

In one embodiment, an antioxidant may be present in the composition. The antioxidant may include, but is not limited to, secondary aromatic amines, benzofuranones, sterically hindered phenols, or any combination thereof.

In one embodiment, a light stabilizer may be present in the composition. The light stabilizer may include, but is not limited to, 2-(2′-hydroxyphenyl)-benzotriazoles, 2-hydroxy-4-alkoxybenzophenones, nickel containing light stabilizers, 3,5-di-tert-butyl-4-hydroxbenzoates, sterically hindered amines (HALS), or any combination thereof.

In one embodiment, a UV absorber may be present in the composition in lieu of or in addition to the light stabilizer. The UV absorber may include, but is not limited to, a benzotriazole, a benzoate, or a combination thereof, or any combination thereof.

In one embodiment, a halogenated flame retardant may be present in the composition. The halogenated flame retardant may include, but is not limited to, tetrabromobisphenol A (TBBA), tetrabromophthalic acid anhydride, dedecachloropentacyclooctadecadiene (dechlorane), hexabromocyclodedecane, chlorinated paraffins, or any combination thereof.

In one embodiment, a non-halogenated flame retardant may be present in the composition. The non-halogenated flame retardant may include, but is not limited to, resorcinol diphosphoric acid tetraphenyl ester (RDP), ammonium polyphosphate (APP), phosphine acid derivatives, triaryl phosphates, trichloropropylphosphate (TCPP), magnesium hydroxide, aluminum trihydroxide, antimony trioxide.

In one embodiment, an acid scavenger may be present in the composition. The acid scavenger may include metal salts of fatty acids such as alkaline earth metal salts, metal oxides, metal carbonates, silicates, and mixtures thereof. Metal salts of fatty acids may include metal salts of stearates such as calcium stearate and zinc stearate. Metal oxides may include magnesium oxide and zinc oxide. Metal carbonates may include sodium carbonate and calcium carbonate, and hydroxy metal carbonates. The silicate may include aluminum silicate.

In one embodiment, a reinforcing filler may be present in the composition. The reinforcing filler may include, but is not limited to, wood flour, glass spheres, glass fibers, graphite, aluminum powder, talc, chalk, carbonates, or any combination thereof. In one embodiment, the composition may be substantially free of a filler. As used herein, substantially free refers to less than about 0.1 wt. %, such as less than about 0.05 wt. %, such as less than about 0.01 wt. %, such as about 0 wt. %.

In one embodiment, a lubricant may be present in the composition. The lubricant may include, but is not limited to, silicone oil, waxes, greases, molybdenum disulfide, or any combination thereof.

In one embodiment, a colorant may be present in the composition. The colorant may include, but is not limited to, inorganic and organic based color pigments.

These additives may be used singly or in any combination thereof. In general, unless stated otherwise, if the additives are utilized, they may be present in an amount of at least about 0.05 wt. %, such as at last about 0.1 wt. %, such as at least about 0.25 wt. %, such as at least about 0.5 wt. %, such as at least about 1 wt. % and generally less than about 20 wt. %, such as less than about 10 wt. %, such as less than about 5 wt. %, such as less than about 4 wt. %, such as less than about 2 wt. %. The sum of the wt. % of all of the components, including any additives if present, utilized in the polymer composition will be 100 wt. %.

The compositions of the present disclosure can be compounded and formed into a mold or a polymer article using any technique known in the art. For instance, the composition can be intensively mixed to form a substantially homogeneous blend. The components can be mixed utilizing a blender, high speed mixer, pelletizer, extruder, or any other method well known in the art. The article can be formed also utilizing compression molding or ram extrusion into a desired shape utilizing conventional techniques. For instance, compression molding may be conducted according to the procedure described in EP 0613923.

For instance, the components can be mixed and heated to a temperature of from about 180 to 250° C. The components may be heated and/or sintered under a pressure of from about 2 to 6 MPa, such as 3 to 5 MPa. Thereafter, the product or composition is then cooled. The cooling may also be conducted under a pressure of from about 7 to about 10 MPa. Generally, the sintering time and cooling time may depend on the thickness of the composition or article.

The composition can be utilized to provide articles for a variety of applications, in particular wherein low wear, excellent tribological properties, and excellent mechanical properties are desired. For instance, the composition can be used to provide articles for the mechanical, food, packaging, chemical, electroplating, ceramics, paper and pulp, electrical, refrigeration, and cryogenic industries.

For instance, the composition may be utilized for to produce any of the following or components for any of the following: profiles for chain/belt drives, curved guide elements, chain reversers, tensioners, profiles for chain racks, slide rails for conveyor systems, wear strips and guides for conveyor systems, rail track disks, impact absorbing elements, bunker and silo linings, fenders, chutes, rail wagons, ships' holds, platforms/dump trucks, suction boxes and screen covers, doctor blades, sealing strips, stripping elements, foils, filter plates, centrifugal pumps, diaphragm pumps, metering pumps, eccentric pumps, butterfly valves, ball valves, slide valves, seals and gaskets, electroplating drums, bearing systems, gearwheels, bellows, bearing bushes, slide and guide rollers, nozzle, stripping elements, connectors, cable clamps, contact breakers and insulating components for current collectors in subways, dynamic seals, sleeves, piston rings, pump packings, skis and snowboards, ice skating rinks, bowling alleys, sliding and functional parts in seatbelt retractor systems, windscreen wiper drives and control rods, windscreen wiper bearings, mirror adjustors, conveyor chains, toothed racks and gearwheels, adjustment mechanisms, sliding bearing blocks, rollers and wear strips, gearwheels in processes/mixers, rollers, and slicers, door hinges, etc.

The UHMW-PE polymer composition and polymer article produced therefrom may exhibit improved tribological properties, low wear, and higher abrasion resistance in comparison to unmodified UHMW-PE and other thermoplastic compositions. According to the present disclosure, the tribological properties are generally measured by the coefficient of friction and wear.

In general, static friction is the friction between two or more surfaces that are not moving relative to each other (ie., both objects are stationary). In general, dynamic friction occurs when two objects are moving relative to each other (ie., at least one object is in motion or repeated back and forth motion). In general, wear refers to the removal of material from or the impairment of a solid surface resulting from friction or impact. As such, when surfaces contact one another, they not only experience friction but they also experience wear.

According to the present disclosure, the composition and polymer article may exhibit a dynamic coefficient of friction against another surface of greater than about 0.05, such as greater than about 0.10, such as greater than about 0.11, such as greater than about 0.12 and generally less than about 0.30, such as less than about 0.20, such as less than about 0.19, such as less than about 0.17, such as less than about 0.16, such as less than about 0.15, utilizing a ball-on-prism configuration with a load of 5 N, sliding speed of 500 mm/s, and a test duration of 10 minutes wherein the ball was comprised of polyoxymethylene such as a tribologically unmodified polyoxymethylene and the plate was comprised of the composition of the present disclosure.

According to the present disclosure, the composition and polymer article may exhibit a dynamic coefficient of friction against another surface of greater than about 0.05, such as greater than about 0.07, such as greater than about 0.09, such as greater than about 0.10, such as greater than about 0.12 such as greater than about 0.15, such as greater than about 0.25, such as greater than about 0.40, such as greater than about 0.60 and generally less than about 1, such as less than about 0.90, such as less than about 0.70, such as less than about 0.50, such as less than about 0.20, such as less than about 0.15, such as less than about 0.12, such as less than about 0.10, as determined utilizing a ball-on-prism configuration with a load of 5 N, sliding speed of 1000 mm/s, and a test duration of 3 minutes wherein the ball was comprised of polyoxymethylene such as a tribologically unmodified polyoxymethylene and the plate was comprised of the composition of the present disclosure.

Additionally, the volumetric material loss obtained during the ball-on-prism tests was extrapolated over 60 minutes in order to determine the long term tribological behavior of the materials. For instance, in one embodiment, the article may not exhibit any substantial wear. For instance, the wear, at a sliding speed of 500 m/s, may be less than 50 μm/h, such as less than 10 μm/h, such as less than 1 μm/h, such as less than about 0.5 μm/h, such as about 0 μm/hr. The wear, at a sliding speed of 1000 m/s, may be higher than the wear at 500 m/s such that the wear is less than about 10,000 μm/h, such as less than about 7,500 μm/h, such as less than about 5,000 μm/h, such as less than about 1,000 μm/h, such as less than about 100 μm/h, such as less than about 1 μm/h, such as about 0 μm/h.

Generally, higher speeds may affect the tribological properties and appearance of the components. For instance, at higher speeds in comparison to lower speeds, unmodified UHMW-PE may become worn while the counter material may melt. For instance, as an example, utilizing a ball-on-prism configuration, a ball may be comprised of unmodified polyoxymethylene while the plate may be comprised of an UHMW-PE composition. When utilizing an unmodified UHMW-PE, at higher speeds such as about 1,000 m/s, the ball may partially melt or even fully melt while the plate may exhibit wear. However, upon modifying the UHMW-PE with a tribological modifier as described herein, the ball may exhibit minimal wear or melting or even no wear or melting while the plate may also exhibit minimal or even no wear.

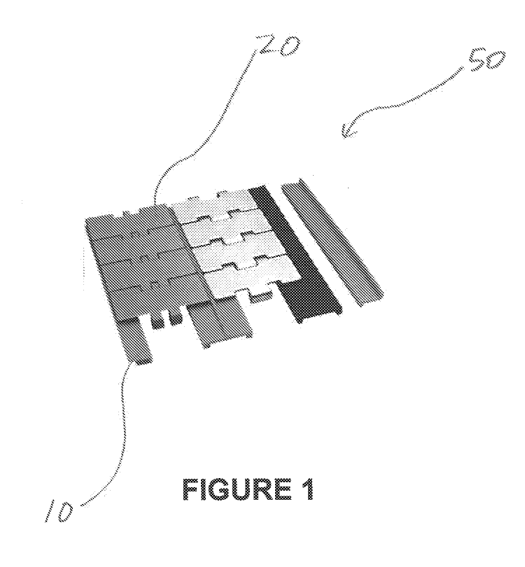

In particular, these properties can be utilized in industries requiring storage and conveying such as those requiring conveyor components. For instance, the UHMW-PE composition of the present disclosure may be utilized in the conveying industry and, as shown in FIG. 1, may be utilized as a wear strip or guide 10 for a conveyor assembly 30. A wear strip or guide 10 is generally a material on which a conveyor chain 20 slides or moves. In one embodiment, the conveyor chain 20 may be comprised of a polyacetal such as a polyoxymethylene and the wear strip or guide 10 may be comprised of the composition of the present disclosure. For instance, as shown in FIG. 1, the wear strip or guide 10 provides a base or foundation upon which the polyacetal chain or chain links 20 glide or move. In certain embodiments, the chains or chain links 20 may glide at high speeds. When these chains are gliding or moving at high speeds, this may result in significant wear and or melting of one or both components. However, by utilizing the UHMW-PE composition of the present disclosure, when operating at higher speeds, wear and/or melting of one or both components in the conveying process may be minimized or even removed.

Accordingly, the composition and article of the present disclosure may exhibit improved wear properties and a higher abrasion resistance when compared to other thermoplastic compositions or UHMW-PE polymer composition not modified with a tribological modifier. For instance, a reduction in the coefficient of friction and an improved wear performance can be achieved with the present composition.

In one embodiment, the above dynamic coefficient of friction values and wear properties are exhibited between the composition or polymer article and various counter-materials. For instance, the above values may be exhibited between the composition or polymer article and a polyester surface such as a polyethylene terephthalate surface. In another embodiment, the above values may be exhibited between the composition or polymer article a metal surface such as a steel surface, or another polyolefin surface such as a polypropylene surface or other polyethylene surface.

The present disclosure may be better understood with reference to the following example.

### EXAMPLE

The examples of the invention are given below by way of illustration and not by way of limitation. The following experiments were conducted in order to show some of the benefits and advantages of the present invention.

### Example 1

The polymer compositions comprising the UHMW-PE polymer and a tribological modifier were produced in accordance with the present disclosure. The relative amount of each component of the composition is provided in Tables 1 and 2.

Reference Samples 1 and 2 utilized a UHMW-PE polymer without tribological modifiers. Samples 1-10 were comprised of a UHMW-PE polymer and at least one tribological modifier such as a silicone oil, a silicone powder, an olefin oligomer, a polytetrafluoroethylene, or a combination thereof.

The components of each composition were mixed and heated to a temperature of from about 180 to 250° C. The composition was compression molded to prepare specimens for testing. Tests were then conducted on the specimens to determine the tribological properties.

The tribological properties (dynamic coefficient of friction and wear) were determined for a system comprising an UHMW-PE polymer composition and a polyoxymethylene surface. The tests were conducted to determine the dynamic coefficient of friction utilizing a high speed tribology tester. A ball-on-prism configuration was utilized with a load of 5N and a test temperature of 23° C. wherein the ball was comprised of unmodified polyoxymethylene and the plate was comprised of an UHMW-PE composition. As shown in Table 1, the test was conducted with a sliding of 500 mm/s for a test duration of 10 minutes. As shown in Table 2, the test was conducted with a sliding speed of 1000 mm/s for a test duration of 3 minutes.

The volumetric wear loss data obtained for the wear analysis utilizing the tests was extrapolated to 60 minutes to determine the long term tribological performance of the materials. In particular, the data was extrapolated to measure the wear of the UHMW-PE article and the polyoxymethylene.

In addition, the appearance of the ball and plate was determined after testing. In particular, the ball and plate were observed to determine the amount of wear and/or melting that may have occurred to each component.

TABLE 1
Sliding Speed of 500 mm/s

| | | Reference | | | | | |
|---|---|---|---|---|---|---|---|
| Sample | | Sample 1 | Sample 1 | Sample 2 | Sample 3 | Sample 4 | Sample 5 |
| UHMW-PE | | 100 | 95 | 90 | 95 | 95 | 95 |
| Silicone oil (wt. %) | | — | 2 | — | — | — | — |
| Ethylene-butene copolymer | | — | 3 | — | — | — | — |
| (wt. %) | | | | | | | |
| Silicone powder with silica | | — | — | 10 | — | — | — |
| (wt. %) | | | | | | | |
| Silicone powder with | | — | — | — | 5 | — | |
| silicone rubber (wt. %) | | | | | | | |
| Silicone powder with | | — | — | — | — | 5 | — |
| polysilsesquioxane particle | | | | | | | |
| (wt. %) | | | | | | | |
| PTFE | | — | — | — | — | — | 5 |
| Dynamic CoF | | 0.292 | 0.114 | 0.121 | 0.151 | 0.128 | 0.191 |
| Wear (μm/h) | | 0 | 0 | 36 | 0 | 0 | 7.3 |
| Appearance | Ball | No wear, | No wear, | Small | No wear, | No wear, | Small |
| After Testing | | no | no | wear, no | no | no | wear, no |
| | | melting | melting | melting | melting | melting | melting |
| | Plate | No wear | No wear | No wear | No wear | No wear | No wear |

TABLE 2
Sliding Speed of 1000 mm/s

| | | Reference | Sample | Sample | Sample | Sample | Sample | Sample |
|---|---|---|---|---|---|---|---|---|
| Sample | | Sample 2 | 6 | 2 | 7 | 8 | 9 | 10 |
| UHMW-PE | | 100 | 95 | 95 | 90 | 95 | 95 | 95 |
| Silicone oil (wt. %) | | — | 5 | 2 | — | — | — | — |
| Ethylene-butene copolymer | | — | — | 3 | — | — | — | — |
| (wt. %) | | | | | | | | |
| Silicone powder with silica | | — | — | — | 10 | — | — | — |
| (wt. %) | | | | | | | | |
| Silicone powder with | | — | — | — | — | 5 | — | — |
| silicone rubber (wt. %) | | | | | | | | |
| Silicone powder with | | — | — | — | — | — | 5 | — |
| polysilsesquioxane particle | | | | | | | | |
| (wt. %) | | | | | | | | |
| PTFE | | — | — | — | — | — | — | 5 |
| Dynamic CoF | | 0.395 | 0.168 | 0.095 | 0.130 | 0.492 | 0.654 | 0.651 |
| Wear (μm/h) | | 2100 | 0 | 0 | 0 | 2984 | 7190 | 5238 |
| Appearance | Ball | Fully | No | No | No | Fully | Fully | Fully |
| After Testing | | melted | wear, | wear, | wear, | melted | melted | melted |
| | | | no | no | no | | | |
| | | | melting | melting | melting | | | |
| | Plate | Worn | No | No | No | Worn | Worn | Worn |
| | | | wear | wear | wear | | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part.

Furthermore, those of ordinary skill in the art will appreciate that the foregoing description is by way of example only, and is not intended to limit the invention so further described in such appended claims.

1. An ultrahigh molecular weight polyethylene composition comprising,
an ultrahigh molecular weight polyethylene,
at least one tribological modifier comprising a silicone oil having a kinematic viscosity of greater than 10,000 mm²/s, an ultrahigh molecular weight silicone, a silicone powder, an olefin oligomer, or any combination thereof.

2. The composition of claim 1, wherein the ultrahigh molecular weight polyethylene has a molecular weight of from 3,000,000 g/mol to 10,000,000 g/mol.

3. The composition of claim 1, wherein the ultrahigh molecular weight polyethylene is present in the composition in an amount of greater than about 75 wt. %.

4. The composition of claim 1, wherein the tribological modifier is present in the composition in an amount of from about 0.1 wt. % to about 20 wt. %.

5. The composition of claim 1, wherein the tribological modifier is comprised of a silicone oil and an olefin oligomer.

6. The composition of claim 5, wherein the olefin oligomer is an ethylene copolymer.

7. The composition of claim 6, wherein the ethylene copolymer is an ethylene-butene copolymer.

8. The composition of claim 1, wherein the silicone powder is comprised of a core-shell silicone powder.

9. The composition of claim 1, wherein the silicone powder is comprised of a silica and a silicone polymer.

10. The composition of claim 9, wherein the silicone polymer is an ultrahigh molecular weight silicone polymer.

11. The composition of claim 9, wherein the silicone polymer is functionalized to comprise an acrylic group, an epoxy group, an amine group, or any combination thereof.

12. The composition of claim 9, wherein a coupling agent bonds the silicone polymer and the silica.

13. The composition of claim 12, wherein the coupling agent is an alkoxysilane coupling agent.

14. The composition of claim 9, wherein the weight ratio of the silica to the silicone powder is from 9:1 to 1:9.

15. The composition of claim 1, wherein the silicone powder is comprised of a silicone resin.

16. The composition of claim 15, wherein the silicone powder is further comprised of a silicone rubber.

17. The composition of claim 15, wherein the silicon resin is comprised of a polysilsesquioxane.

18. The composition of claim 8, wherein the core is comprised of a silicone rubber and the shell is comprised of a silicone resin.

19. The composition of claim 8, wherein the core is comprised of a silica and the shell is comprised of a silicone polymer.

20. The composition of claim 1, wherein the silicone powder has an average particle size of from about 0.5 μm to about 50 μm.

21. The composition of claim 1, wherein the composition exhibits a dynamic coefficient of friction against a polyoxymethylene of from about 0.05 to about 0.30, as measured at a sliding speed of 500 mm/s.

22. The composition of claim 1, wherein the composition exhibits a dynamic coefficient of friction against a polyoxymethylene of from about 0.05 to about 1.0, as measured at a sliding speed of 1000 mm/s.

23. The composition of claim 1, wherein the at least one tribological modifier comprises a silicone oil, the silicone oil having a kinematic viscosity of greater than 15,000 mm²/s to about 50,000 mm²/s.

24. The composition of claim 1, wherein the tribological modifier comprises the ultrahigh molecular weight silicone, wherein the ultrahigh molecular weight silicone is not crosslinked.

25. A polymer article comprising the composition of claim 1.

26. The polymer article of claim 25, wherein the article is a wear strip or guide.
